(19) United States
(12) Patent Application Publication
(10) Pub. No.: US 2018/0012238 A1
(43) Pub. Date: Jan. 11, 2018

(54) APPLICATION RECOMMENDATION DEVICES AND APPLICATION RECOMMENDATION METHOD

(71) Applicant: RAZER (ASIA-PACIFIC) PTE. LTD., SINGAPORE (SG)

(72) Inventors: Joseph Mario Giannuzzi, Cedar Park, TX (US); Jesse Michael Recinos, Austin, TX (US)

(21) Appl. No.: 15/548,934

(22) PCT Filed: Feb. 10, 2015
(86) PCT No.: PCT/SG2015/000036

§ 371 Date: Aug. 4, 2017

(51) Int. Cl. G06Q 30/02; G06Q 50/00; G06Q 30/06

(52) U.S. Cl. CPC G06Q 30/0201; G06Q 30/0631; G06Q 50/01

(57) ABSTRACT

According to various embodiments, an application recommendation device may be provided. The application recommendation device may include: a metrics determination circuit configured to determine a plurality of metrics; and a user input circuit configured to receive user input; a weight determination circuit configured to determine a plurality of weights based on the user input; a weighting circuit configured to determine a weighted metric based on weighting the plurality of metrics based on the plurality of weights; and a recommendation determination circuit configured to determine a recommended application based on the weighted metric.

### TECHNICAL FIELD

Various embodiments generally relate to application recommendation devices and application recommendation method.

### BACKGROUND

DT (desktop) gaming systems such as Windows, Android, and Mac gaming systems and console gaming systems may be driven by content and access to the content designed for them. Content may be “free to play” or “paid”. While there are many online store fronts available to garners, there is no standard way in which garners can search through or filter the various types of online content delivery systems to find what they want or are most interested in. Thus, there is a need for an efficient way in which garners can search through the various types of online content delivery systems to find what they want or are most interested in.

### SUMMARY OF THE INVENTION

According to various embodiments, an application recommendation device may be provided. The application recommendation device may include: a metrics determination circuit configured to determine a plurality of metrics; and a user input circuit configured to receive user input; a weight determination circuit configured to determine a plurality of weights based on the user input; a weighting circuit configured to determine a weighted metric based on weighting the plurality of metrics based on the plurality of weights; and a recommendation determination circuit configured to determine a recommended application based on the weighted metric.

According to various embodiments, an application recommendation method may be provided. The application recommendation method may include: determining a plurality of metrics; receiving user input; determining a plurality of weights based on the user input; determining a weighted metric based on weighting the plurality of metrics based on the plurality of weights; and determining a recommended application based on the weighted metric.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1A shows an application recommendation device according to various embodiments;

FIG. 1B shows a flow diagram illustrating an application recommendation method according to various embodiments;

FIG. 2 shows a diagram illustrating an example of a flow and how a recommendation is derived and delivered to target platforms according to various embodiments; and

FIG. 3 shows an example of weighting according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

In this context, the application recommendation device as described in this description may include a memory which is for example used in the processing carried out in the application recommendation device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

The reference to any prior art in this specification is not, and should not be taken as an acknowledgement or any form of suggestion that the referenced prior art forms part of the common general knowledge in Australia (or any other country).

In order that the invention may be readily understood and put into practical effect, particular embodiments will now be described by way of examples and not limitations, and with reference to the figures.

Various embodiments are provided for devices, and various embodiments are provided for methods. It will be understood that basic properties of the devices also hold for the methods and vice versa. Therefore, for sake of brevity, duplicate description of such properties may be omitted.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed or attached, or just in contact without any fixation, and it will be understood that both direct coupling or indirect coupling (in other words: coupling without direct contact) may be provided.

The rise of games played cross-platform may be becoming more relevant and important to the gamers. The various game platforms may deliver a nearly common game playing experience in some cases and the need to be able to obtain content from various virtual store fronts via digital distribution that can serve a gamer's different device may be important. A recommendation engine according to various embodiments allows for the easy aggregation, subsequent weighting and filtering of the games that a user would consider playing.

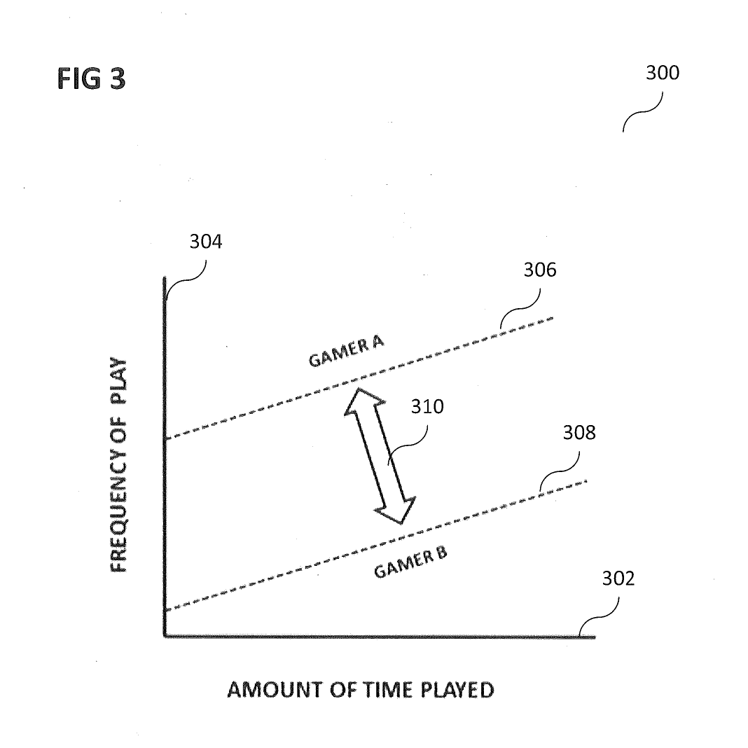

FIG. 3 shows an illustration 300 of an example of weighting according to various embodiments based on two “related influences” (for example amount of time played on the x axis 302 and frequency of play on the y axis 304) and two trend lines (a first trend line 306 for a first gamer (who may be referred to as gamer A) and a second trend line 308 for a second gamer (who may be referred to as gamer B)). The weighting may be based on the proximity and common trajectory of the trend lines (more or higher weighting would be applied on parallel or converging) trend lines.

In the following, influences may refer to the measurable data use as part of the recommendation engine, metrics may refer to how the influences are measured or analyzed, and assumptions may refer to why the influence is relevant to the recommendation.

According to various embodiments, an influence may be game genre. Corresponding assumptions may include or may be that players tend to favor a few specific play styles. A metric may include or may be a game's genre or elements of genre, as well as its art style, play style, setting, mood, and/or rules.

According to various embodiments, an influences may include sales, download, and active player trends. Corresponding assumptions may include or may be that games that have a buzz attract more interest and awareness. A corresponding metric may include most frequently purchased or downloaded titles for various online stores within a specific period of time (such as Steam, Google Play, Origin, GoG), and/or frequency with which specific titles are mentioned and their relative ranking within each list.

According to various embodiments, an influence may include or may be a friend recommendation. Corresponding assumptions may include or may be that people buy and/or play games to be social, and people trust recommendations from friends. A corresponding metric may include: direct recommendation from a friend, invitation to join a game from a friend, and/or by using the highest indexed games in a friends account.

According to various embodiments, an influence may include or may be scheduled events. Corresponding assumptions may include that real-world and in-game events often spark renewed interest in the title. A corresponding metric may include events related to Genres/Titles that are already relevant to you.

According to various embodiments, an influence may include or may be time played. Corresponding assumptions may include that people spend time on things they like. A corresponding metric may include or may be an amount of time, in minutes, that a game is played (for example determined by the state of the app or for an online game, or a time a user is logged in, for example into a gaming platform).

According to various embodiments, an influence may include or may be Friend of a Friend (f.o.f.). Corresponding assumptions may include or may be that you often find you have things in common with friends of friends. A corresponding metric may include or may be, for a given title, frequency and amount of time played between players with a common connection (one, possibly two degrees of separation).

According to various embodiments, an influence may include or may be player preset. Corresponding assumptions may include or may be that players use similar hardware/peripheral configurations for games of same playstyle. A corresponding metric may include or may be: mouse dpi, use of macros, polling rate, and/or number of mouse buttons.

According to various embodiments, an influence may include or may be patches and/or updates. Corresponding assumptions may include or may be that new DLC, Interface updates, and major bug fixes spur interest from new and old players. Corresponding metrics may include or may be: scheduled Patch, update, DLC (Downloadable Content), and/or degree of impact (for example point release, expansion back, genre-bridging mod).

According to various embodiments, an influence may include or may be groups (for example clans, guilds, etc). A corresponding metric may include or may be a popularity of a game within a user's regular gaming group (for example a percentage of people within a gaming group, e.g. a Steam chat group, that own a specific game).

According to various embodiments, an influence may include or may be game rating. Corresponding assumptions may include or may be that better games receive higher ratings, regardless of personal preferences. Corresponding metrics may include or may be user and/or critic reviews (for example as taken from Steam store, Metacritic, etc), and/or the rating level and where applicable, number of reviewers who contributed to the rating.

According to various embodiments, an influence may include or may be player state and/or mood. Corresponding assumptions may include or may be that in the near future, technology will allow real-time, continuous interpretation of a user's physical, mental, and emotional state. Games should be recommended accordingly to either accommodate or counter this just as a tired person may listen to soothing music to sleep or dance music to reinvigorate themselves. Corresponding metrics may include or may be: heartrate, reaction time, breathing patterns, blood flow, temperature, eye movement, and/or facial muscle movements.

According to various embodiments, an influence may include or may be player environment. Corresponding assumptions may include or may be that as a precursor to the above, certain games can be favored according to time of day, time of year, seasons, and weather based on the assumption that patterns of correlation will be detected. Corresponding metrics may include or may be time of day in player's current locale, time of day in player's usual locale, outdoor lighting (based on sunset/sunrise, clouds), and/or weather patterns (temperature, rain, wind, heavy snow).

According to various embodiments, an influence may include or may be a cost and/or business model. Corresponding metrics may include or may be download to Own vs Free-to-Play vs Subscription and/or associated cost(s).

According to various embodiments, an influence may include or may be a user defined influence or another influence. Corresponding metrics may include or may be: game controller support (for example none, partial, full), multiplayer (for example none, co-op, pvp, local), cloud-sync of save games, streaming, language/localization, and/or DRIVI (digital rights management).

DT (desktop) gaming systems such as Windows, Android, and Mac gaming systems and console gaming systems may be driven by content and access to the content designed for them. Content may be “free to play” or “paid”. While there are many online store fronts available to garners, there is no standard way in which gainers can search through or filter the various types of online content delivery systems to find what they want or are most interested in. An adaptable recommendation engine according to various embodiments may solve a number of problems and enable a better user content consumption experience.

Various embodiments may provide an efficient way in which garners can search through the various types of online content delivery systems to find what they want or are most interested in.

According to various embodiments, a (for example adaptable) game and/or application recommendation engine may be provided. According to various embodiments, a game application recommendation platform may be provided.

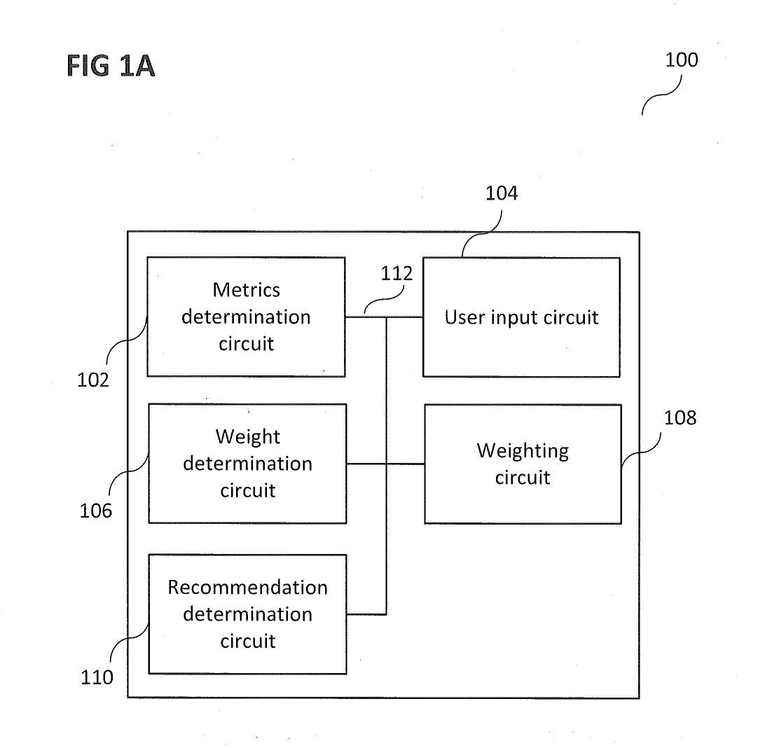

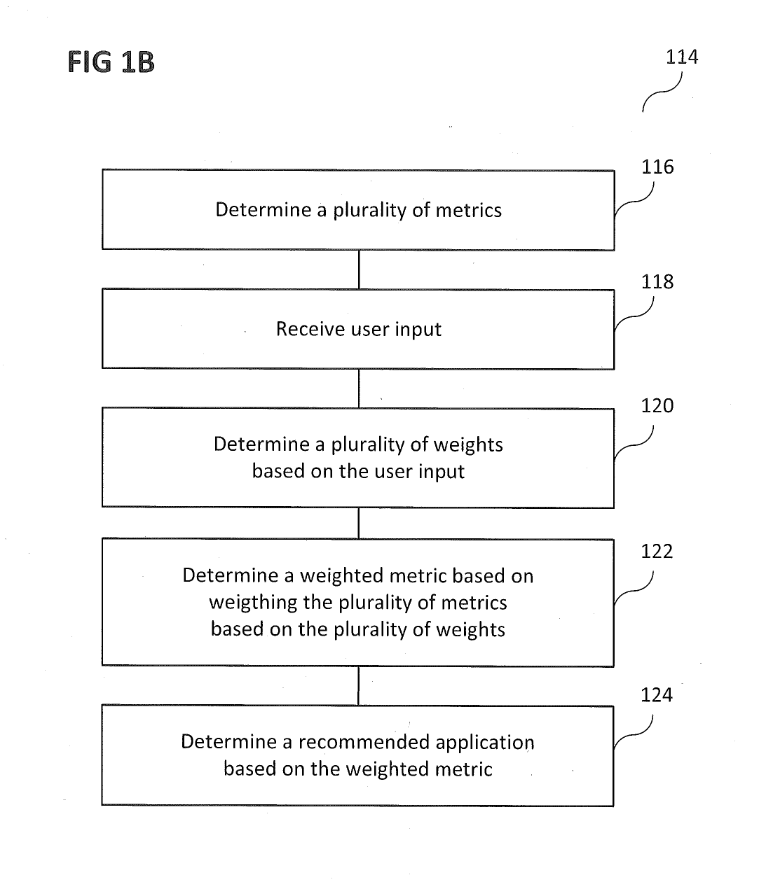

FIG. 1A shows an application recommendation device 100 according to various embodiments. The application recommendation device 100 may include a metrics determination circuit 102 configured to determine a plurality of metrics. The application recommendation device 100 may further include a user input circuit. 104 configured to receive user input. The application recommendation device 100 may further include a weight determination circuit 106 configured to determine a plurality of weights based on the user input. The application recommendation device 100 may further include a weighting circuit 108 configured to determine a weighted metric based on weighting the plurality of metrics based on the plurality of weights. The application recommendation device 100 may further include a recommendation determination circuit 110 configured to determine a recommended application based on the weighted metric. The metrics determination circuit 102, the user input circuit 104, the weight determination circuit 106, the weighting circuit 108, and the recommendation determination circuit 110 may be coupled with each other, like indicated by line 112, for example electrically coupled, for example using a line or a cable, and/or mechanically coupled.

In other words, according to various embodiments, an application to be recommended to a user may be determined based on user metrics and weights (for example one weight corresponding (or related to) each of the user metrics), and the weights may be set or modified by the user.

According to various embodiments, the application may be a game, for example a computer game.

According to various embodiments, the plurality of metrics may be pairwise different. According to various embodiments, each metric of the plurality of metrics may include or may be or may be included information indicating at least one of the following information: applications used by a user of the application recommendation device; gaming interests of the user; application genres used by the user; gaming genres used by the user; trends of applications used by the user; trends of games used by the user; a profile of the user in social media; recommendations of a friend of the user; recommendations of a friend of a friend of the user; events scheduled by the user; time the user has used an application; time the user has used a game; presents of the user; updated performed by the user; patches performed by the user; user-defined data.

According to various embodiments, the metrics determination circuit 102 may be configured to determine at least a subset of the plurality of metrics from social media.

According to various embodiments, the metrics determination circuit 102 may be configured to determine at least a subset of the plurality of metrics from a computer of the user.

According to various embodiments, the user input may include or may be or may be included in an instruction to select a metric of the plurality of metrics and to decrease a weight related to the selected metric.

According to various embodiments, the user input may include or may be or may be included in an instruction to select a metric of the plurality of metrics and to increase a weight related to the selected metric.

According to various embodiments, the user input may include or may be a pre-determined value, and an instruction to select a metric of the plurality of metrics and to set a weight related to the selected metric to the pre-determined value.

According to various embodiments, each metric of the plurality of metrics may be indicated by a number (for example a real number or an integer number). According to various embodiments, the weighting circuit 108 may be configured to determine the weighted metric based on, for each metric of the plurality of metrics, a multiplication, the multiplication based on the number indicating the metrics an a weight of the plurality of weights related to the metric, and the weighting circuit 108 may be configured to determine the weighted metric based on summing up the results of the multiplications.

According to various embodiments, basic equations for determining the weighting of “I” influences, 1 to N where “N” represents the first to last influence used (wherein I/1 [Relative Weighting] may represent the first relative weighting, I/2 [Relative Weighting] may represent the second relative weighting, and so on; I/N [Relative Weighting] may represent the N-th (or last) relative weighting) may be as follows:

o) I/1 [Relative Weighting]+I/N [Relative Weighting] (which may represent “Additive” weighting); in other words: the relative weightings may be summed;

o) I/1 [Relative Weighting]+I/2 [Relative Weighting] *I/3 [Relative Weighting] (which may represent “Multiplicative & Additive” weighting); in other words: the relative weightings may be multiplied or summed

o) I/1 [Relative Weighting] *I/2 [Relative Weighting] (which may representing “Multiplicative” weighting); in other words: the relative weightings may be multiplied.

In all cases the higher the weighting the higher the recommendation value.

According to various embodiments, the user input may include or may be or may be included in an instruction to modify the recommendation.

According to various embodiments, the user input may include or may be or may be included in an instruction to filter the recommendation.

FIG. 1B shows a flow diagram 114 illustrating an application recommendation method according to various embodiments. In 116, a plurality of metrics may be determined. In 118, user input may be received. In 120, a plurality of weights may be determined based on the user input. In 122, a weighted metric may be determined based on weighting the plurality of metrics based on the plurality of weights. In 124, a recommended application may be determined based on the weighted metric.

According to various embodiments, the plurality of metrics may be pairwise different. According to various embodiments, each metric of the plurality of metrics may include or may be or may be included in information indicating at least one of the following information: applications used by a user of the application recommendation method; gaming interests of the user; application genres used by the user; gaming genres used by the user; trends of applications used by the user; trends of games used by the user; a profile of the user in social media; recommendations of a friend of the user; recommendations of a friend of a friend of the user; events scheduled by the user; time the user has used an application; time the user has used a game; presents of the user; updated performed by the user; patches performed by the user; user-defined data.

According to various embodiments, the application recommendation method may further include determining at least a subset of the plurality of metrics from social media.

According to various embodiments, the application recommendation method may further include determining at least a subset of the plurality of metrics from a computer of the user.

According to various embodiments, the user input may include or may be or may be included an instruction to select a metric of the plurality of metrics and to decrease a weight related to the selected metric.

According to various embodiments, the user input may include or may be or may be included an instruction to select a metric of the plurality of metrics and to increase a weight related to the selected metric.

According to various embodiments, the user input may include or may be or may be a pre-determined value, and an instruction to select a metric of the plurality of metrics and to set a weight related to the selected metric to the pre-determined value.

According to various embodiments, each metric of the plurality of metrics may be indicated by a number. According to various embodiments, the application recommendation method may further include determining the weighted metric based on, for each metric of the plurality of metrics, a multiplication, the multiplication based on, the number indicating the metrics an a weight of the plurality of weights related to the metric. According to various embodiments, the application recommendation method may further include determining the weighted metric based on summing up the results of the multiplications.

According to various embodiments, the user input may include or may be or may be included an instruction to modify the recommendation.

According to various embodiments, the user input may include or may be or may be included an instruction to filter the recommendation.

According to various embodiments, a method of automatically recommending a game/application to a user on a platform (for example Razer Synapse or Razer Cortex) by obtaining and establishing patterns of user behavior from key user metrics such as gaming interests, game genres, social media profiles from social media networks, games or browsers. According to various embodiments, there may be provided an intelligent user defined feedback element which allows the user to directly influence the outcome of the recommendation by adjusting the key metrics to a desired purpose.

According to various embodiments, a search and recommendations engine may be provided. Instead of “fixed function” influences by a small number of parameters that cannot be altered, refined or re-defined as the users interests change or evolve, device and methods according to various embodiments may be user configurable, adaptable and/or user tunable as described herein.

According to various embodiments, a recommendation engine, for example an adaptable recommendation engine, for example a user definable recommendation engine, a recommendation method, an application recommendation, an application recommendation engine and/or a game recommendation engine may be provided.

According to various embodiments, a game or application recommendation platform may be provided which allows a user to perform the following steps:

1. Extracting key metrics from user application programs (for example social media networks, games, and/or browsers) on the computing device, the key metrics for example based on gaming interests and/or gaming genres and/or gaming trends and/or social media profiles;

2. Establishing patterns in user behavior based on gaming interests and/or gaming genres and/or gaining trends and/or social media profiles (according to various embodiments, patterns may be equated to the influences as described above; a specific pattern or in other words a “trend’ may be a rise in the amount of time a game is downloaded and/or played; a pattern may also be how often a game is recommended based on another gaming site);

3. Determining the weightage of the extracted key metrics and patterns to specific gaming genres, trends and/or interests;

4. Recommending games based on weightage of the extracted key metrics;

5. Adapting user input on the recommended games by allowing user to rate recommended games;

6. Allowing user to optionally apply filters to displayed recommendations by selecting parameters such as genre, number of players, etc.; and

7. Adapting the applied filters into the game recommendation by establishing patterns in user behavior to perform further game recommendations.

According to various embodiments, a client side application may be provided that uses various parameters to influence the game and/or application recommendation.

According to various embodiments, the game or application recommendation device or method may be implemented in the following forms:

1) A game scanner and a launcher so that games may be tracked while users are playing, when, and for how long (for example when (for example at which time or at which day of the week) the users are playing and for how long they are playing a game);

2) A communication messenger (for example, Razer Comms) as a way to track relationships between users and judge the weighting which should be used when applying recommendations (patterns) from one user to another;

3) A cloud based service that keeps track of a user's profile; and/or

4) A vehicle in the form of a software application for recommending games (for example, Razer Cortex). It will be understood that the use of the word “vehicle” is as a “general descriptor” for the output of an application or set or meta data from a WEB site or a subset of data from a software or online based application or other data that may be used in part to help formulate a recommendation for an application or game.

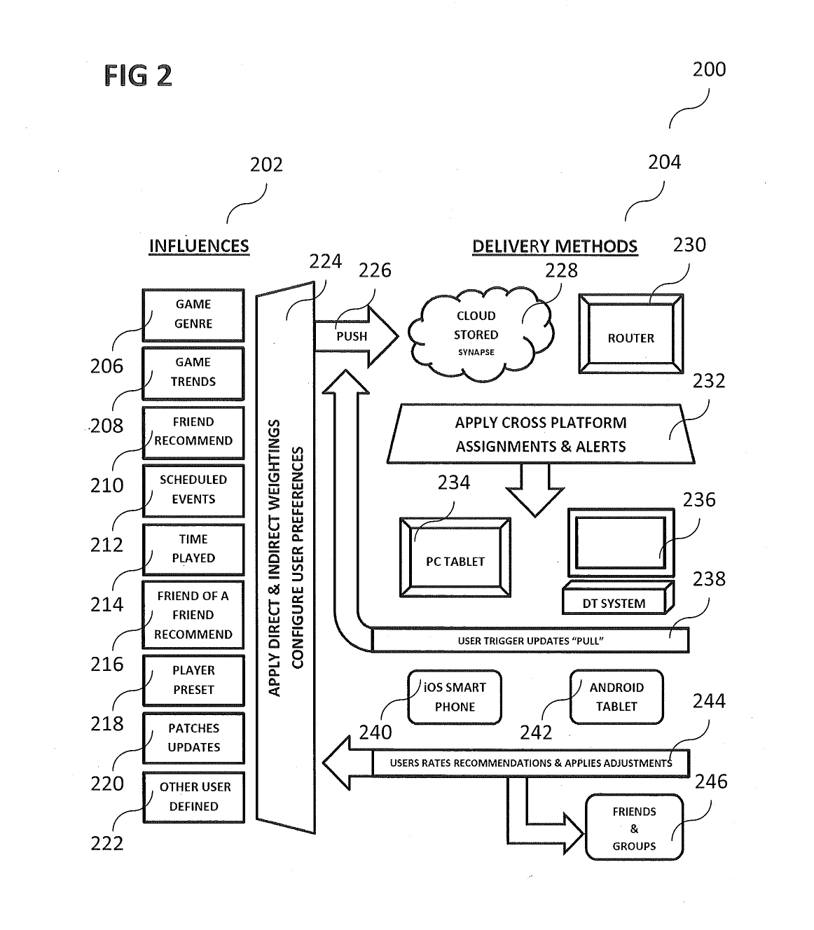

FIG. 2 shows a diagram 200 illustrating an example of a flow and how the recommendation is derived and delivered to the target platforms according to various embodiments. In the left side of FIG. 2, influences 202 to the recommendations are illustrated. In the right side of FIG. 2, delivery methods 204 are illustrated. Influences 204 may include game genre 206, game trends 208, fried recommendations 210, scheduled evens 212, time played 214, recommendations 216 from a fried of a friend, player preset 218, patches (or updates) 220, or other user defined data 222. In 224, direct and/or indirect weightings may be applied to the influences 202 and user preferences may be configured. In 226, the generated recommendations may be transmitted, for example pushed to a cloud storage 228, which, for example via a router 230, may provide cross platform assignments and alerts (like illustrated in 232), for example to PC tablets 234, desktop systems 236, iOS smart phones 240, and Android tables 242. In 238, a user may trigger an update (in other words: a user may “pull” data); this may be provided alternatively or in addition to the “push” of 226. In 224, the user may rate the recommendations (and may for example provide these ratings to friends and groups 246), and may apply adjustments (for example on how the influences are used in 224 for generating the recommendations, for example the weights of the influences in the generations of the recommendations).

The recommendation engine according to various embodiments may have the following properties:
it may be adaptable, (in other words, an adaptable, non-fixed function may be provided);
it may be configurable or definable;
it may support or address all cross-platform recommendations;
it may extend to all friends and groups;
it may extend to different delivery methods or through a cloud based interface; and
it may support user feedback and/or configurable preferences.

Various embodiments may be designed to be adaptable by way of utilizing various feedback loops influenced directly and indirectly with user oversight.

According to various embodiments, a uniform recommendation engine or a standard way in which to set search parameters to gain access to free to play game, paid game or application content may be provided. According to various embodiments, content may be dynamically weighted, and may be applied in various situations, without being necessarily tailored to the particular gamers interests be it a FPS (first-person shooter), RTS (real-time strategy game) or MMO (massively multiplayer online game) type of content. According to various embodiments, other influences may be applied to the search criteria or specific or structured weightings may be applied or may be changed over time as the gamer's/user's interest changes.

The following examples pertain to further embodiments.

Example 1 is an application recommendation device comprising: a metrics determination circuit configured to determine a plurality of metrics; and a user input circuit configured to receive user input; a weight determination circuit configured to determine a plurality of weights based on the user input; a weighting circuit configured to determine a weighted metric based on weighting the plurality of metrics based on the plurality of weights; and a recommendation determination circuit configured to determine a recommended application based on the weighted metric.

In example 2, the subject-matter of example 1 can optionally include that the plurality of metrics are pairwise different, and wherein each metric of the plurality of metrics comprises information indicating at least one of the following information: applications used by a user of the application recommendation device; gaming interests of the user; application genres used by the user; gaming genres used by the user; trends of applications used by the user; trends of games used by the user; a profile of the user in social media; recommendations of a friend of the user; recommendations of a friend of a friend of the user; events scheduled by the user; time the user has used an application; time the user has used a game; presents of the user; updated performed by the user; patches performed by the user; user-defined data.

In example 3, the subject-matter of any one of examples 1 to 2 can optionally include that the metrics determination circuit is configured to determine at least a subset of the plurality of metrics from social media.

In example 4, the subject-matter of any one of examples 1 to 3 can optionally include that the metrics determination circuit is configured to determine at least a subset of the plurality of metrics from a computer of the user.

In example 5, the subject-matter of any one of examples 1 to 4 can optionally include that the user input comprises an instruction to select a metric of the plurality of metrics and to decrease a weight related to the selected metric.

In example 6, the subject-matter of any one of examples 1 to 5 can optionally include that the user input comprises an instruction to select a metric of the plurality of metrics and to increase a weight related to the selected metric.

In example 7, the subject-matter of any one of examples 1 to 6 can optionally include that the user input comprises a pre-determined value, and an instruction to select a metric of the plurality of metrics and to set a weight related to the selected metric to the pre-determined value.

In example 8, the subject-matter of any one of examples 1 to 7 can optionally include that each metric of the plurality of metrics is indicated by a number; wherein the weighting circuit is configured to determine the weighted metric based on, for each metric of the plurality of metrics, a multiplication, the multiplication based on the number indicating the metrics an a weight of the plurality of weights related to the metric, and wherein the weighting circuit is configured to determine the weighted metric based on summing up the results of the multiplications.

In example 9, the subject-matter of any one of examples 1 to 8 can optionally include that the user input comprises an instruction to modify the recommendation.

In example 10, the subject-matter of any one of examples 1 to 9 can optionally include that the user input comprises an instruction to filter the recommendation.

Example 11 is an application recommendation method comprising: determining a plurality of metrics; receiving user input; determining a plurality of weights based on the user input; determining a weighted metric based on weighting the plurality of metrics based on the plurality of weights; and determining a recommended application based on the weighted metric.

In example 12, the subject-matter of example 11 can optionally include that the plurality of metrics are pairwise different, and wherein each metric of the plurality of metrics comprises information indicating at least one of the following information: applications used by a user of the application recommendation method; gaming interests of the user; application genres used by the user; gaming genres used by the user; trends of applications used by the user; trends of games used by the user; a profile of the user in social media; recommendations of a friend of the user; recommendations of a friend of a friend of the user; events scheduled by the user; time the user has used an application; time the user has used a game; presents of the user; updated performed by the user; patches performed by the user; user-defined data.

In example 13, the subject-matter of any one of examples 11 to 12 can optionally include determining at least a subset of the plurality of metrics from social media.

In example 14, the subject-matter of any one of examples 11 to 13 can optionally include determining at least a subset of the plurality of metrics from a computer of the user.

In example 15, the subject-matter of any one of examples 11 to 14 can optionally include that the user input comprises an instruction to select a metric of the plurality of metrics and to decrease a weight related to the selected metric.

In example 16, the subject-matter of any one of examples 11 to 15 can optionally include that the user input comprises an instruction to select a metric of the plurality of metrics and to increase a weight related to the selected metric.

In example 17, the subject-matter of any one of examples 11 to 16 can optionally include that the user input comprises a pre-determined value, and an instruction to select a metric of the plurality of metrics and to set a weight related to the selected metric to the pre-determined value.

In example 18, the subject-matter of any one of examples 11 to 17 can optionally include that each metric of the plurality of metrics is indicated by a number; wherein the application recommendation method further comprises determining the weighted metric based on, for each metric of the plurality of metrics, a multiplication, the multiplication based on the number indicating the metrics an a weight of the plurality of weights related to the metric, and wherein the application recommendation method further comprises determining the weighted metric based on summing up the results of the multiplications.

In example 19, the subject-matter of any one of examples 11 to 18 can optionally include that the user input comprises an instruction to modify the recommendation.

In example 20, the subject-matter of any one of examples 11 to 19 can optionally include that the user input comprises an instruction to filter the recommendation.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An application recommendation device comprising:
a metrics determination circuit configured to determine a plurality of metrics; and
a user input circuit configured to receive user input;
a weight determination circuit configured to determine a plurality of weights based on the user input;
a weighting circuit configured to determine a weighted metric based on weighting the plurality of metrics based on the plurality of weights; and
a recommendation determination circuit configured to determine a recommended application based on the weighted metric.

2. The application recommendation device of claim 1,
wherein the plurality of metrics are pairwise different, and wherein each metric of the plurality of metrics comprises information indicating at least one of the following information: applications used by a user of the application recommendation device; gaming interests of the user; application genres used by the user; gaming genres used by the user; trends of applications used by the user; trends of games used by the user; a profile of the user in social media; recommendations of a friend of the user; recommendations of a friend of a friend of the user; events scheduled by the user; time the user has used an application; time the user has used a game; presents of the user; updated performed by the user; patches performed by the user; user-defined data.

3. The application recommendation device of claim 1,
wherein the metrics determination circuit is configured to determine at least a subset of the plurality of metrics from social media.

4. The application recommendation device of claim 1,
wherein the metrics determination circuit is configured to determine at least a subset of the plurality of metrics from a computer of the user.

5. The application recommendation device of claim 1,
wherein the user input comprises an instruction to select a metric of the plurality of metrics and to decrease a weight related to the selected metric.

6. The application recommendation device of claim 1,
wherein the user input comprises an instruction to select a metric of the plurality of metrics and to increase a weight related to the selected metric.

7. The application recommendation device of claim 1,
wherein the user input comprises a pre-determined value, and an instruction to select a metric of the plurality of metrics and to set a weight related to the selected metric to the pre-determined value.

8. The application recommendation device of claim 1,
wherein each metric of the plurality of metrics is indicated by a number;
wherein the weighting circuit is configured to determine the weighted metric based on, for each metric of the plurality of metrics, a multiplication, the multiplication based on the number indicating the metrics an a weight of the plurality of weights related to the metric, and wherein the weighting circuit is configured to determine the weighted metric based on summing up the results of the multiplications.

9. The application recommendation device of claim 1,
wherein the user input comprises an instruction to modify the recommendation.

10. The application recommendation device of claim 1,
wherein the user input comprises an instruction to filter the recommendation.

11. An application recommendation method comprising:
determining a plurality of metrics;
receiving user input;
determining a plurality of weights based on the user input;
determining a weighted metric based on weighting the plurality of metrics based on the plurality of weights; and
determining a recommended application based on the weighted metric.

12. The application recommendation method of claim 11,
wherein the plurality of metrics are pairwise different, and wherein each metric of the plurality of metrics comprises information indicating at least one of the following information: applications used by a user of the application recommendation method; gaming interests of the user; application genres used by the user; gaming genres used by the user; trends of applications used by the user; trends of games used by the user; a profile of the user in social media; recommendations of a friend of the user; recommendations of a friend of a friend of the user; events scheduled by the user; time the user has used an application; time the user has used a game; presents of the user; updated performed by the user; patches performed by the user; user-defined data.

13. The application recommendation method of claim 11, further comprising:
determining at least a subset of the plurality of metrics from social media.

14. The application recommendation method of claim 11, further comprising:
determining at least a subset of the plurality of metrics from a computer of the user.

15. The application recommendation method of claim 11,
wherein the user input comprises an instruction to select a metric of the plurality of metrics and to decrease a weight related to the selected metric.

16. The application recommendation method of claim 11,
wherein the user input comprises an instruction to select a metric of the plurality of metrics and to increase a weight related to the selected metric.

17. The application recommendation method of claim 11,
wherein the user input comprises a pre-determined value, and an instruction to select a metric of the plurality of metrics and to set a weight related to the selected metric to the pre-determined value.

18. The application recommendation method of claim 11,
wherein each metric of the plurality of metrics is indicated by a number;
wherein the application recommendation method further comprises determining the weighted metric based on, for each metric of the plurality of metrics, a multiplication, the multiplication based on the number indicating the metrics an a weight of the plurality of weights related to the metric, and wherein the application recommendation method further comprises determining the weighted metric based on summing up the results of the multiplications.

19. The application recommendation method of claim 11,
wherein the user input comprises an instruction to modify the recommendation.

20. The application recommendation method of claim 11,
wherein the user input comprises an instruction to filter the recommendation.
